(19) United States
(12) Patent Application Publication
(10) Pub. No.: US 2025/0353997 A1
(43) Pub. Date: Nov. 20, 2025

(54) CELLULOSE-BASED RESIN COMPOSITION AND MOLDED BODY USING SAME

(71) Applicants: NEC Corporation, Minato-ku, Tokyo (JP); NEC Platforms, Ltd., Kawasaki-shi, Kanagawa (JP)

(72) Inventors: Kiyohiko TOYAMA, Tokyo (JP); Yuto SANO, Tokyo (JP); Shukichi TANAKA, Tokyo (JP); Midori SHIMURA, Tokyo (JP); Takuma OZAWA, Kanangawa (JP)

(73) Assignees: NEC Corporation, Minato-ku, Tokyo (JP); NEC Platforms, Ltd., Kawasaki-shi, Kanagawa (JP)

(21) Appl. No.: 18/291,977

(22) PCT Filed: Jul. 29, 2022
(86) PCT No.: PCT/JP2022/029269

§ 371 Date: Jan. 30, 2025

(30) Foreign Application Priority Data
Jul. 29, 2021 (JP) 2021-124854

(51) Int. Cl. C08L 1/12; C08K 5/521

(52) U.S. Cl. CPC C08L 1/12; C08K 5/521

(57) ABSTRACT

Provided is a cellulose-based resin composition that is capable of forming a molded body excellent in flame retardancy and processing stability and having high design property. The present invention relates to a cellulose-based resin composition including: component (A): cellulose acetate, component (B): a specific phosphoric acid ester, and component (C): an anti-dripping agent, wherein a content of the component (B) is 25% by mass or more and 30% by mass or less based on 100% by mass of a total content of the component (A) and the component (B), and a content of the component (C) is 0.01% by mass or more and 1% by mass or less based on 100% by mass of a total content of the component (A), the component (B) and the component (C).

### TECHNICAL FIELD

The present invention relates to a cellulose-based resin composition and a molded body using the same.

### BACKGROUND ART

Since bioplastics made from plant components as raw materials can contribute to measures against petroleum depletion or measures against global warming, their use in general products such as packages, containers, and fibers as well as durable products such as electronics and automobiles has also been started.

General bioplastics, such as polylactic acid, polyhydroxyalkanate, and modified starch, are all made from starch-based materials, that is, edible parts. Accordingly, for fear of future food shortage, it had been desired to develop a novel bioplastic using a non-edible part as a raw material.

Such a non-edible part is typified by cellulose, which is a major component of wood or vegetation, and various bioplastics obtained using this have been developed and commercialized.

Since these plant-derived resins are generally flammable, flame retardant measures are necessary when they are used in applications that require a high degree of flame retardancy, such as a home appliance and a housing for office automation equipment. In particular, when a resin composition comprising a plant-derived resin is used for a housing of an electrical product, it is necessary to satisfy a flame retardant standard such as UL94 standard.

Resin compositions containing flame retardants had been studied for the purpose of improving flame retardancy. For example, Patent Document 1 discloses a resin composition comprising a polylactic acid resin, a cellulose ester, an aromatic polycarbonate resin, a compatibilizer and a flame retardant. Patent Document 2 discloses a resin composition comprising a cellulose ester and a cyclic phosphorus compound having a specific structure. Patent Document 3 discloses a resin composition comprising a cellulose ester, a polycarbonate resin, a plasticizer comprising a polymer having a predetermined number average molecular weight, and a phosphorus-containing flame retardant. Patent Document 4 discloses a cellulose-based resin composition comprising a cellulose ester-based resin, a phosphoric acid ester having a specific structure, and polytetrafluoroethylene in each predetermined content.

On the other hand, in recent years, there has been a demand for resin molded products with a high-quality appearance and high design property without coating. When resin molded products are not coated, emission of volatile organic compounds (VOC) can be suppressed and coating cost can be reduced during manufacturing, and for the resulting molded products, the problem of deteriorated appearance caused by peeling or deterioration of the coating can be solved.

### CITATION LIST

### Patent Literature

Patent Document 1: Japanese Patent Laid-Open Publication No. 2006-111858
Patent Document 2: Japanese Patent Laid-Open Publication No. 2011-241236
Patent Document 3: Japanese Patent Laid-Open Publication No. 2011-225841
Patent Document 4: Japanese Patent No. 6239504

### SUMMARY OF INVENTION

### Technical Problem

However, regarding the resin compositions described in Patent Documents 1 to 4, studies on a cellulose-based resin composition capable of forming a molded body excellent in flame retardance and mechanical strength had been insufficient.

An object of the present invention is to provide a cellulose-based resin composition capable of forming a molded body excellent in flame retardancy and having high design property, and a molded body formed using the same.

### Solution to Problem

One aspect of the present embodiment relates to the following matters.

A cellulose-based resin composition comprising:
component (A): cellulose acetate,
component (B): one or more phosphoric acid esters selected from the group consisting of triphenyl phosphate, triethyl phosphate, tributyl phosphate and tricresyl phosphate, and
component (C): an anti-dripping agent,
wherein a content of the component (B) is 25% by mass or more and 30% by mass or less based on 100% by mass of a total content of the component (A) and the component (B), and
a content of the component (C) is 0.01% by mass or more and 1% by mass or less based on 100% by mass of a total content of the component (A), component (B) and component (C).

### Advantageous Effect of Invention

According to the present embodiment, it is possible to provide a cellulose-based resin composition capable of forming a molded body having high flame retardancy and excellent design property, and a molded body formed using the same.

### DESCRIPTION OF EMBODIMENTS

A cellulose-based resin composition of the present embodiment (also simply referred to as “resin composition” or “cellulose acetate resin composition”) comprises:
component (A): cellulose acetate,
component (B): one or more phosphoric acid esters selected from the group consisting of triphenyl phosphate, triethyl phosphate, tributyl phosphate and tricresyl phosphate, and
component (C): an anti-dripping agent,
wherein a content of the component (B) is 25% by mass or more and 30% by mass or less based on 100% by mass of a total content of the component (A) and the component (B), and
a content of the component (C) is 0.01% by mass or more and 1% by mass or less based on 100% by mass of a total content of the component (A), component (B) and component (C).

The resin composition of the present embodiment has high flame retardancy and processing stability, and is capable of forming a molded body excellent in design property. Each component will be explained below.

### <Component (A)>

The cellulose-based resin composition of the present embodiment comprises cellulose acetate (also described as “CA”) as component (A). Cellulose acetate in which an acetyl group is introduced into at least a part of hydroxy groups of cellulose used as a raw material may be used.

Cellulose is a straight-chain polymer obtained by polymerizing β-D-glucose molecules (β-D-glucopyranose) represented by the following formula (1) via a β (1->4) glycoside bond. Each of glucose units constituting cellulose has three hydroxy groups (in the formula, n represents a natural number). In the present embodiment, an acetyl group is introduced into such cellulose by using these hydroxy groups.

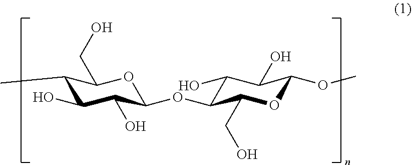

Cellulose is a main component of a plant and can be obtained by a separation treatment for removing other components such as lignin from a plant. Other than those thus obtained, cotton (for example, cotton linters) having a high cellulose content and pulp (for example, wood pulp) may be used directly or after they are purified. As the shape, size and form of the cellulose or a derivative thereof to be used as a raw material, a powder form cellulose or a derivative thereof having an appropriate particle size and particle shape is preferably used in view of reactivity, solid-liquid separation and handling. For example, a fibrous or powdery cellulose or a derivative thereof having a diameter of 1 to 100 μm (preferably 10 to 50 μm) and a length of 10 μm to 100 mm (preferably 100 μm to 10 mm) may be used, but is not limited thereto.

The polymerization degree of the cellulose in terms of polymerization degree (average polymerization degree) of glucose preferably falls within the range of 50 to 5000, more preferably 100 to 3000 and further preferably 100 to 1000. If the polymerization degree is extremely low, the strength and heat resistance of the produced resin may not be sufficient in some cases. Conversely, if the polymerization degree is extremely high, the melt viscosity of the produced resin becomes extremely high, interfering with molding in some cases.

The cellulose acetate used in the present embodiment can be obtained by introducing an acetyl group by use of hydroxy groups of a cellulose.

The above acetyl group can be introduced by reacting a hydroxy group of a cellulose and an acylating agent. The acetyl group corresponds to an organic group portion introduced in place of a hydrogen atom of a hydroxy group of the cellulose. The acylating agent is a compound having at least one functional group reactive to a hydroxy group of a cellulose: examples thereof include compounds having a carboxyl group, a carboxylic halide group or a carboxylic anhydride group. Specific examples of the compound include aliphatic monocarboxylic acid (acetic acid), an acid halide and acid anhydride thereof (acetic anhydride).

The average number of acetyl groups to be introduced per glucose unit of a cellulose (DS_{AC}) (an acetyl group introduction ratio): in other words, the average number of hydroxyl groups substituted with acetyl groups per glucose unit (degree of substitution of a hydroxyl group) may be set to fall within the range of 0.1 to 3.0. In order to obtain an introduction effect of an acetyl group sufficiently, particularly, in view of e.g., water resistance and flowability, DS_{AC} is preferably 2.0 or more, more preferably 2.2 or more and further preferably 2.4 or more. From the viewpoint of obtaining the effect of other groups (e.g., hydroxy group) while obtaining the introduction effect of an acetyl group sufficiently, DS_{AC} is preferably 2.9 or less and more preferably 2.8 or less.

By introducing an acetyl group into a cellulose as described above, it is possible to reduce intermolecular force (intramolecular bond) of the cellulose and to improve plasticity of the cellulose acetate resin composition.

As the residual amount of hydroxy groups increases, the maximum strength and heat-resistance of the cellulose acetate resin composition tend to increase; whereas water absorbability tends to increase. In contrast, as the conversion ratio (degree of substitution) of hydroxy groups increases, water absorbability tends to decrease, plasticity and breaking strain tend to increase; whereas, maximum strength and heat resistance tend to decrease. In consideration of these tendencies etc., the conversion ratio of hydroxy groups can be appropriately set.

The average number of the remaining hydroxy groups per glucose unit of the cellulose acetate (hydroxy group remaining degree) may be set to fall within the range of 0 to 2.9. From the view of maximum strength, heat-resistance and the like, hydroxy groups may remain. For example, the hydroxy group remaining degree may be 0.01 or more and further 0.1 or more. Particularly, in view of flowability, the hydroxy group remaining degree of a final cellulose acetate is preferably 1.0 or less, more preferably 0.8 or less and further preferably 0.6 or less.

The molecular weight of cellulose acetate, as a weight average molecular weight, is preferably in the range of 10,000 to 400,000, more preferably in the range of 50,000 to 350,000, further preferably in the range of 100,000 to 300,000, still more preferably in the range of 150,000 to 250,000. If the molecular weight is excessively large, flowability of cellulose acetate resin composition becomes low. As a result, it may be difficult to not only process it but also uniformly mix it in some cases. Conversely, if the molecular weight is excessively small, physical properties such as impact resistance of the cellulose acetate resin composition may deteriorate in some cases. The weight average molecular weight can be determined by gel permeation chromatography (GPC) (commercially available standard polystyrene can be used as a reference sample).

### <Component (B)>

The cellulose-based resin composition of the present embodiment comprises, as component (B), one or more phosphoric acid esters selected from the group consisting of triphenyl phosphate (also described as “TPP”), triethyl phosphate, tributyl phosphate, and tricresyl phosphate. Component (B) functions as a flame retardant and a plasticizer, and can impart flame retardancy and moldability to the resin composition. Moreover, these specific phosphoric acid esters are highly compatible with cellulose acetate and do not generate white clouding when mixed with cellulose acetate, and thus a highly transparent resin composition can be obtained.

In one aspect of the present embodiment, component (B) preferably comprises triphenyl phosphate (TPP). In one aspect, a content of TPP in the total amount of component (B) is preferably 80% by mass or more, more preferably 90% by mass or more, and may be 100% by mass. TPP has low volatility and high compatibility with component (A). Moreover, the use of TPP can form a resin composition with high mechanical strength.

Component (B) may be used alone, or may be used in combination of two or more types.

In addition, in one aspect of the present embodiment, from the viewpoint of obtaining a molded body with high design property, it is preferred that the content of a phosphoric acid ester having low compatibility with component (A) (referred to as “phosphoric acid ester (b′)”) is small. Examples of the phosphoric acid ester (b′) include: a compound represented by the following formula:

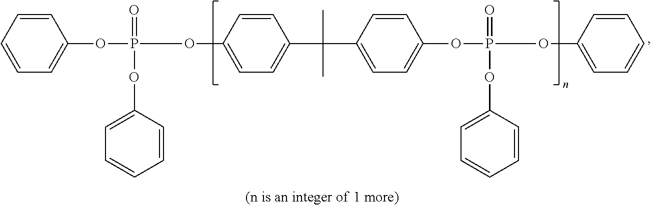

a compound represented by the following formula:

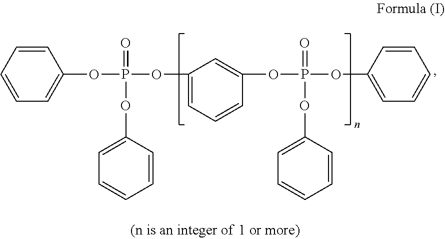

a compound represented by the following formula:

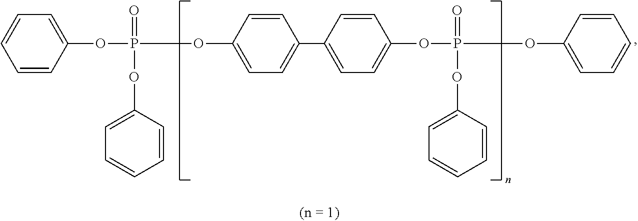

cresyl di-2,6-xylenyl phosphate, and a condensed phosphoric acid ester-based compound represented by [(CH₃)₂C₆H₃O]₂P(O)OC₆H₄OP(O)[OC₆H₃(CH₃)₂]₂. The content of the phosphoric acid ester (b′) in the resin composition is preferably 3% by mass or less, more preferably 1% by mass or less, and further more preferably 0% by mass.

In the cellulose-based resin composition, the content of component (A) based on 100% by mass of the total content of component (A) and component (B) is preferably 70% by mass or more, more preferably 72% by mass or more, and preferably 75% by mass or less.

In the cellulose-based resin composition, the content of component (B) based on 100% by mass of the total content of component (A) and component (B) is preferably 25% by mass or more, and preferably 30% by mass or less, more preferably 28% by mass or less. When the content of component (B) is within the range, the resin composition can be made which has excellent processing stability and flame retardancy and reduced oozing (bleed-out). If the content of component (B) is too high, bleed-out may occur in some cases. On the other hand, if the content of component (B) is too low, processing stability and flame retardancy may become insufficient in some cases. Processing stability can be evaluated by the method described in Examples.

The total content of component (A) and component (B) based on 100% by mass of the total amount of the cellulose-based resin composition is preferably 70% by mass or more, more preferably 80% by mass or more, further preferably 90% by mass or more, still more preferably 95% by mass or more, and preferably less than 99.8% by mass, more preferably 99.5% by mass or less, further preferably 99% by mass or less, still more preferably 98% by mass or less.

### <Component (C)>

The cellulose-based resin composition of the present embodiment comprises an anti-dripping agent as component (C). The inclusion of component (C) allows the cellulose-based resin composition to shrink when heated, which results in preventing the molten resin from dropping (dripping) and spreading combustion. The anti-dripping agent is preferably a fluorine-based anti-dripping agent (fluorine-containing polymer), and more preferably contains a fluorine-containing polymer to form a fibrous structure (fibrillar structure) in the resin composition. Blending the fluorine-containing polymer can enhance the suppressing effect of the drip phenomenon during combustion.

Examples of the anti-dripping agent include fluorine-based resins such as polytetrafluoroethylene (PTFE), tetrafluoroethylene-based copolymers (e.g., tetrafluoroethylene/hexafluoropropylene copolymers, etc.), acrylic-modified resins of polytetrafluoroethylene, polyvinylidene fluoride and polyhexafluoropropylene, a compound of an alkali metal salt of perfluoroalkanesulfonic acid and an alkaline-earth metal salt of perfluoroalkanesulfonic acid such as sodium perfluoromethanesulfonate, potassium perfluoro-n-butanesulfonate, potassium perfluoro-t-butanesulfonate, sodium perfluorooctanesulfonate, and calcium perfluoro-2-ethylhexanesulfonate. Further, as the fluorine-containing polymer, there can also be used fluoropolymers of various forms such as fine powdery fluoropolymers, aqueous dispersions of fluoropolymers, a mixture of powdery fluoropolymer and acrylonitrile-styrene copolymer, and a mixture of powdery fluoropolymer and polymethyl methacrylate. Similarly, a silicone compounds such as silicone rubbers and a layered silicate such as talc may be blended as another anti-dripping agent. These may be used alone or in combination of two or more.

Among these, a fluorine-based anti-dripping agent having fibril-forming ability is preferred, and polytetrafluoroethylene (PTFE) is particularly preferred. The molecular weight of the fluorine-based anti-dripping agent (particularly PTFE) is preferably 1,000,000 to 10,000,000, more preferably 2,000,000 to 9,000,000, in terms of number-average molecular weight determined from standard specific gravity. Such PTFE may be in solid form or in the form of an aqueous dispersion. In one embodiment, a content of PTFE in the total amount of component (C) is preferably 80% by mass or more, more preferably 90% by mass or more, and may be 100% by mass.

In the cellulose-based resin composition, the content of component (C) based on 100% by mass of the total content of component (A), component (B) and component (C) is preferably 0.01% by mass or more, more preferably 0.1% by mass or more, more preferably 0.2% by mass or more, further preferably 0.3% by mass or more, still more preferably 0.5% by mass or more, and is preferably 1.0% by mass or less, more preferably 0.8% by mass or less. If the content of component (C) is too high, processing stability may decrease and design properties such as transparency may deteriorate in some cases. On the other hand, if the content of component (C) is too low, flame retardancy may become insufficient in some cases.

The cellulose-based resin composition according to the present embodiment may comprise other components without impairing the desired appearance and properties when formed into a molded body. In one aspect, for example, the total amount of component (A), component (B) and component (C) based on the total of the cellulose-based resin composition is set in the range of preferably 75 to 100% by mass, more preferably 80% by mass or more, more preferably 90% by mass or more, preferably 95% by mass or more, more preferably 98% by mass or more, and further preferably 99% by mass or more.

The resin composition of the present embodiment may comprise a colorant as described below, but in the embodiment that does not comprise a colorant, it is preferred that the resin composition has high transparency. Although it may be colorless or colored, it is preferably colorless and transparent. The high transparency allows for good coloration when a colorant and the like are added, and thus it is possible to form a molded body having a high-quality appearance, that is, being excellent in design property.

In one aspect of the present embodiment, the haze value of a molded body having a thickness of 500 μm formed of the resin composition that does not comprise a colorant is preferably 35% or less, more preferably 10% or less.

The resin composition of the present embodiment may comprise a colorant in addition to components (A), (B), and (C).

### (Colorant)

In one aspect, the cellulose-based resin composition of the present embodiment may comprise a colorant such as a black colorant.

The content of the colorant such as a black colorant is not limited, but may be set in the range of 0.01 to 10 phr based on the total mass of components other than the colorant (it means 0.01 to 10 parts by mass based on 100 parts by mass of the total mass of components other than the colorant in the cellulose-based resin composition. The basis for the content of the colorant is the same below.). From the viewpoint of obtaining a sufficient coloring effect, the content of the colorant is preferably 0.05 phr or more, preferably 0.09 phr or more, preferably 0.1 phr or more, based on the total mass of components other than the colorant. From the viewpoint of suppressing the excess amount of colorant while obtaining sufficient coloring effect, the content is preferably 5 phr or less, more preferably 3 phr or less, and further preferably 2 phr or less.

From the viewpoint of appearance such as glossiness, the content of the colorant is preferably 1 phr or less, more preferably 0.3 phr or less, further preferably 0.2 phr or less, and particularly preferably 0.1 phr or less.

As the black colorant, carbon black is preferable.

The average particle diameter of the carbon black is preferably from 1 to 20 nm, more preferably from 5 to 20 nm, and further preferably from 8 to 18 nm. As the average particle diameter is smaller, the brightness of the molded body is lower, and accordingly the high-quality black (jet black color) appearance is likely to be obtained. Conversely, the average particle diameter is larger, the dispersibility tends to be higher. From these viewpoints, it is preferable to use a carbon black having a particle diameter in the above range.

The average particle diameter is an arithmetic average diameter of particles obtained by observing particles of carbon black with an electron microscope.

In one aspect, the specific surface area of the carbon black is, but is not limited to, preferably 140 m²/g or more, and more preferably 180 m²/g or more from the viewpoint of jet blackness and the like of the molded product. From the viewpoint of dispersibility, the carbon black of 1000 m²/g or less may be used, the carbon black of 700 m²/g or less may be used, and the carbon black of 500 m²/g or less may be used. In terms of relation between particle diameter and specific surface area, generally as the particle diameter is smaller, the specific surface area is larger. From the viewpoint of the brightness and appearance of the molded product and the dispersibility of the particles, it is preferable to use carbon black having a BET specific surface area in the above range. This specific surface area is the BET specific surface area (JIS K6217) obtained by S-BET equation from the nitrogen-adsorbed amount.

In one aspect, the carbon black is preferably acidic, specifically preferably has pH5 or less, more preferably pH4 or less, and still more preferably pH3.5 or less. By using such an acidic carbon black (having a low pH value), the brightness of the molded body can be lowered. For example, a carbon black having preferably pH2.5 to 4, more preferably pH2.5 to 3.5 may be suitably used.

The pH value is obtained by measuring a mixed solution of carbon black and distilled water by a glass-electrode pH meter. The specific measurement method is as follows. 100 ml of boiled and degassed pure water is added to 10 g of sample. The mixture is boiled on a hot plate for 15 minutes and cooled to room temperature. Thereafter, the supernatant is removed and pH of the resultant muddy substance is measured by a glass-electrode pH meter.

Due to interaction or binding of an acidic group (for example, carboxylic acid group) on the surface of such acidic carbon black and a polar group (for example, hydroxy group) of cellulose acetate, affinity thereof is improved and high dispersion of carbon black occurs, which presumably contributes to reduction in brightness.

As colorants other than the black colorant, organic or inorganic pigments or dyes may be used.

The resin composition may contain, as other components, an additive usually used in general resin materials for molding, as long as the purpose of the present embodiment is not impaired. Examples of the additive include an antioxidant such as a phenol-based compound and a phosphorous compound, a light stabilizer, an ultraviolet absorber, an antistatic agent, an antibacterial/antifungal agent, a filler and the like. In particular, an additive usually used in common cellulose-based resins may be contained.

To the resin composition according to the present embodiment, if necessary, an inorganic or organic granular or fibrous filler may be added while considering maintaining transparency. Addition of filler makes it possible to improve strength and rigidity. Examples of the filler include mineral particles (talc, mica, baked siliceous earth, kaolin, sericite, bentonite, smectite, clay, silica, quartz powder, glass beads, glass powder, glass flake, milled fiber, wollastonite, etc.), boron-containing compounds (boron nitride, boron carbide, titanium boride, etc.), metal carbonates (magnesium carbonate, heavy calcium carbonate, light calcium carbonate, etc.), metal silicates (calcium silicate, aluminum silicate, magnesium silicate, magnesium aluminosilicate, etc.), metal oxides (magnesium oxide, etc.), metal sulfates (calcium sulfate, barium sulfate, etc.), metal carbides (silicon carbide, aluminum carbide, titanium carbide, etc.), metal nitrides (aluminum nitride, silicon nitride, titanium nitride, etc.), white carbon and various metal foils. Examples of the fibrous filler include organic fibers (natural fiber, papers, etc.), inorganic fibers (glass fiber, asbestos fiber, carbon fiber, silica fiber, silica alumina fiber, wollastonite, zirconia fiber, potassium titanate fiber, etc.) and metal fibers. These fillers may be used singly or in combination of two or more types.

In one aspect of the present embodiment, the resin composition may comprise a glass fiber. The inclusion of the glass fiber in the resin composition improves the strength of the molded body. Although the glass fiber is not particularly limited, the fiber length of the glass fiber in the shape before melt-kneading is preferably 0.5 mm or more, and preferably 30 mm or less, more preferably 10 mm or less. The cross-sectional shape of the glass fiber is not particularly limited, and examples thereof include circular, elliptical, long-oval, and non-circular shapes. The fiber diameter of the glass fiber when the cross-sectional area is converted to a perfect circle may be, for example, 3 to 20 μm. In one aspect of the present embodiment, the content of the glass fiber based on the total mass of the resin composition may be 0% by mass, but is preferably 0.5% by mass or more, more preferably 1% by mass or more, further preferably 3% by mass or more, and preferably 20% by mass or less, more preferably 10% by mass or less, further preferably 8% by mass or less.

In one aspect, the resin composition of the present embodiment preferably has a low content of a polylactic acid resin and an aromatic polycarbonate resin. If the polylactic acid resin or the aromatic polycarbonate resin is contained, white cloudiness occurs due to low compatibility with cellulose acetate, which makes it difficult to obtain a molded product excellent in design property. The content of these components is preferably 3% by mass or less, more preferably 1% by mass or less, and further preferably 0% by mass, based on the total mass of the resin composition.

In one aspect, the resin composition of the present embodiment preferably has a low content of inorganic flame retardants such as metal hydroxides (aluminum hydroxide, calcium hydroxide, magnesium hydroxide, or the like). The inclusion of an inorganic flame retardant causes white clouding of the resin composition, making it difficult to obtain a molded body excellent in design property. Moreover, when the content of the inorganic flame retardant is small, a molded body having high impact resistance is easily obtained. The content of the inorganic flame retardant is preferably 3% by mass or less, more preferably 1% by mass or less, and further preferably 0% by mass, based on the total mass of the resin composition.

### <Method for Producing Cellulose-Based Resin Composition>

A method for producing the cellulose-based resin composition is not particularly limited, and for example, the cellulose-based resin composition may be obtained by melting and mixing component (A), component (B), component (C) and, if necessary, other components in a usual mixer. As the mixer, for example, a compounding apparatus such as a tumbler mixer, a ribbon blender, a single-screw or multi-screw mixing extruder, a kneader, or a kneading roll may be used. After the melt-mixing, if necessary, granulation into an appropriate shape may be carried out: for example, pellets may be formed by a pelletizer.

### <Molded Body>

The molded body formed using the cellulose-based resin composition according to the present embodiment may be formed into a desired shape by a usual molding method, and the shape is not limited and the thickness of the molded body is not limited. From the viewpoint of the strength of the molded body, the thickness is preferably 0.5 mm or more, more preferably 0.8 mm or more. Furthermore, from the viewpoint of flame retardancy, the thickness is preferably 1.0 mm or more, more preferably 1.6 mm or more, more preferably 2.0 mm or more, and further preferably 3.2 mm or more. On the other hand, the upper limit of the thickness of the molded body is not particularly limited and may be appropriately set depending on the required shape, strength, etc., and for example, even if the thickness is set to 10 mm or less, or even 5 mm or less, sufficient physical properties can be achieved.

Since each component is distributed over the entire molded body of the present embodiment (the entirety of any direction, including the thickness direction), a high-quality appearance can be obtained in any shape without coating, a decorative film or the like.

The cellulose-based resin composition according to the present embodiment can be formed into a molded body in accordance with an intended use by a common molding method such as injection molding, injection compression molding, extrusion molding, and hot press molding, or the like.

Since the molded body formed of the cellulose-based resin composition according to the present embodiment is excellent in flame retardancy and design property, the molded body may be applied to a housing, an exterior package, a decorative plate, and a decorative sheet, and may be used in place of, for example, members used in electronic devices, home appliances, building materials, furniture, and automobiles. The molded body may be used in, for example, housing and exterior parts of electronic devices or home appliances, interior members of building materials, and interior materials of automobiles.

According to the present embodiment, it is possible to provide products including a molded body formed using the resin composition of the present invention, such as electronic devices or home appliances, automobiles, building materials, furniture, or the like.

Examples of use for electronic devices or home appliances include housings for personal computers, fixed phones, mobile phone terminals, smart phones, tablets, POS terminals, routers, projectors, speakers, lighting fixtures, copiers, multifunction devices, calculators, remote controllers, refrigerators, washing machines, humidifiers, dehumidifiers, video recorders/players, vacuum cleaners, air conditioners, rice cookers, electric shavers, electric toothbrushes, dishwashers, and broadcast equipment: dial plates and outer packages for timepieces; and cases for mobile terminals such as smart phones.

Examples of use for automobiles include interior parts such as instrument panels, dashboards, cup holders, door trims, armrests, door handles, door locks, handles, brake levers, ventilators and shift levers.

### EXAMPLES

Hereinafter, an embodiment of the present invention will be explained in details by using examples, but the present invention is not limited to these examples.

Each component used in the production of the resin compositions of Examples and Comparative Examples is shown below.

### <Component (A)>

(a1) Cellulose acetate (CA) (manufactured by Daicel, product name: L-50, acetyl group introduction ratio (degree of substitution) DS=2.4, degree of acetylation: 55%, degree of polymerization based on 6% viscosity: 180)

### <Component (B)>

(b1) Triphenyl phosphate (TPP) (manufactured by Daihachi Chemical Industry, product name: TPP)
   <Phosphoric Acid Ester (b′)>
(b1′) The compound represented by the following formula:

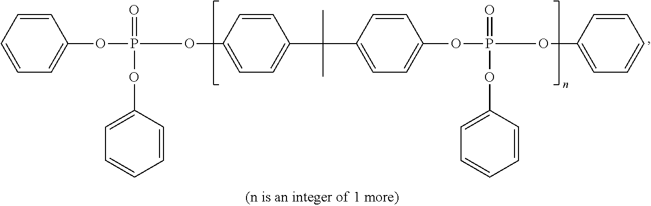

(manufactured by ADEKA Co., Ltd., product name: ADEKA STAB FP-600)
(b2′) The compound represented by the following formula:

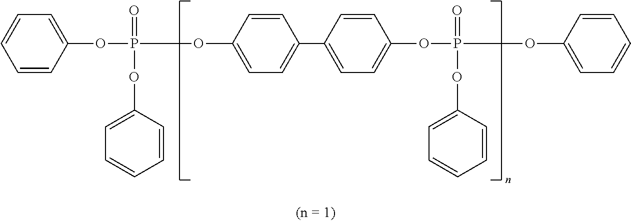

(manufactured by ADEKA Co., Ltd., product name: ADEKA STAB FP-900L)
(b3′) The compound represented by the following formula:

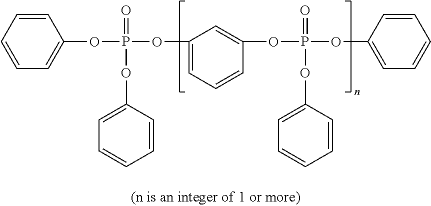

(manufactured by ADEKA Co., Ltd., product name: ADEKA STAB PFR)
(b4′) Cresyl di-2,6-xylenyl phosphate (manufactured by Daihachi Chemical Industry Co., Ltd., trade name: PX-110)
(b5′) [(CH₃)₂C₆H₃O]₂P(O)OC₆H₄OP(O)[OC₆H₃(CH₃)₂]₂ (Daihachi Chemical Co., Ltd., Product name: PX-200)

### <Component (C)>

(c1) Polytetrafluoroethylene (PTFE) (manufactured by Daikin Industries, Ltd., product name: Polyflon MPA FA-500H)

### <Colorant>

(d1) Carbon black (acidic carbon black (average particle diameter: 13 nm, pH 3) (manufactured by Mitsubishi Chemical Corporation, product name: Mitsubishi Carbon Black #2650))

### (Compatibility)

In order to confirm the compatibility of component (a1) and each phosphoric acid ester, they were mixed so that the mass ratio satisfies that component (a1): phosphoric acid ester=80:20 and kneaded in the same manner as described below, and then the appearances thereof were observed.

When component (b1) was used as the phosphoric acid ester, it was found that it was transparent without generating white clouding and compatibility was high.

When components (b1′), (b2′), (b3′), (b4′), and (b5′) were used as phosphoric acid esters, respectively, it was found that white clouding was generated and the compatibility was low.

### Examples 1 to 7, Comparative Examples 1 to 9

The materials shown in Tables 2 to 4 were prepared as constituent materials of the intended cellulose-based resin compositions. Next, the constituent materials were thoroughly mixed by hand mixing at the blending ratios shown in Tables 2 to 4. Note that the resin materials were dried in advance at 80° C. for 5 hours. The ratios of component (a1) and component (b1) are each the proportions (mass %) based on 100 mass % of the total of component (a1) and component (b1). The content of component (c1) is the proportion (mass %) based on 100 mass % of the total content of components (a1), (b1) and (c1). The blending amount of component (d1) is a proportion based on 100 parts by mass of components other than the colorant, and the unit thereof is phr.

### (Kneading Method)

The obtained mixture was put into a co-rotating twin-screw extruder (manufactured by STEER, product name: Omega30H [q30, L/D=60]), kneaded at a kneading temperature of 200° C. and a rotation speed of 120 rpm, and then recovered by water cooling to form a pellet. The resulting pellet was dried at 80° C. for 5 hours.

### <Processing Stability (Discharge Stability of Kneading)>

The stability of the strands of the resin composition discharged from the discharge port of the extruder was evaluated.

The evaluation criteria are as follows.
∘: A strand was stably discharged.
Δ: A strand was discharged but a pulsation was observed.
x: A strand was discharged, but a pulsation was large and thus it could not be taken out.

### (Preparation of Sample for Combustion Test: Evaluation Sample 1)

The obtained pellets were dried again at 80° C. for 5 hours immediately before molding and used in an injection molding machine (manufactured by Toshiba Machine, product name: EC20P) to produce a molded body (evaluation sample 1) having the following shape.
Molded body: length 125 mm, width 13 mm, thickness 3.2 mm,

The molding conditions were set as follows.
Cylinder temperature of the molding machine: 190-230° C.
Mold temperature: 60-70° C.
Holding pressure: 60-100 MPa

The following measurements were performed using the obtained evaluation sample 1.

### <Combustion Test (UL94V Test)>

In the combustion test, the test piece for combustion test (evaluation sample 1) obtained by injection molding was left in a constant temperature room at a temperature of 23° C. and a humidity of 50% for 48 hours, and then the test was conducted in accordance with the UL94 test (combustion test for plastic materials for parts in appliances) released by Underwriters Laboratories. UL94V refers to a method of evaluating flame retardancy based on the combustion time, the dripping property and the like after flame (20±1 mm flame) of a burner is contacted for 10 seconds to the bottom edge of the test piece which is held vertically and has a predetermined size, and the evaluation is classified into classes indicated in the following Table 1.

TABLE 1

| Judgment item | V-0 | V-1 | V-2 |
|---|---|---|---|
| Each flaming combustion time after | ≤10 sec | ≤30 sec | ≤30 sec |
| first-time (t1) and second-time | | | |
| (t2) contact with flame | | | |
| Total flaming combustion time of | ≤50 sec | ≤250 sec | ≤250 sec |
| 5 samples (t1 + t2 of 5 samples) | | | |
| Total of flaming combustion time | ≤30 sec | ≤60 sec | ≤60 sec |
| (t2) and flameless combustion time | | | |
| (t3) after second-time flame contact | | | |
| Combustion reached to the holding | absent | absent | absent |
| clamp of each sample (flaming or | | | |
| flameless combustion) | | | |
| Ignition of marking cotton by | absent | absent | present |
| flaming substances or drips | | | |

The order of flame retardancy from best to worst is V-0, V-1, and V-2. Here, those that did not fall under any of the ranks from V-0 to V-2 (i.e. those that were low in flame retardancy) were classified as V-non-conforming.

The above flaming combustion time is a time length in which flaming combustion of the test piece continues after the ignition source (burner) is removed; and t1 is the combustion time after the first-time flame contact: t2 is the combustion time after the second-time flame contact; and t3 is an afterglow (non-flaming combustion) time after the second-time flame contact. The second-time flame contact is carried out by applying a flame of the burner to the test piece immediately after the flame goes out after the first-time flame contact, for 10 seconds. Furthermore, the ignition of the cotton by the dripping is determined by whether the marking cotton placed about 300±10 mm below the lower end of the test piece is ignited by drops (drips) from the test piece.

### (Measurement of Brightness)

Brightness was measured by determining the reflection of the obtained evaluation sample 1 in accordance with the SCI method (including regular reflection) by a spectrophotometer (manufactured by Konica Minolta, Inc., product name: spectrophotometer CM-3700A, in accordance with JIS Z 8722 condition c, ISO7724/1, CIE No. 15, ASTM E1164, DIN5033 Teil 7). Measurement diameter/illumination diameter was SAV: 3×5 mm/5×7 mm. Reflection measurement conditions were di: 8° and de: 8° (diffused illumination 8° direction light receiving); viewing field was 10°; light source was D65 light source; and UV condition was 100% Full. The brightness herein refers to L* of CIE1976L*a*b* color space. The lower value of brightness is more excellent in jet-blackness. Brightness was measured for samples containing colorant (d1) (Table 2). Table 2 shows the values based on Comparative Example 1.

### (Preparation of Sample for Haze Measurement: Evaluation Sample 2)

The obtained pellets were dried again at 80° C. for 5 hours immediately before molding and used in a heat press molding machine (manufactured by Tester Sangyo, product name: SA-303-II-S) to produce a molded body (evaluation sample 2) having the following shape.
Molded body: disk-shaped molded body having a diameter of 50 mm and a thickness of 500 μm

The molding conditions were set as follows.
Set temperature: 210° C.
Pressure: 10 MPa

The following measurements were performed using the obtained evaluation sample 2.

### (Measurement of Haze)

The haze (haze value) of the obtained evaluation sample 2 was measured using a haze meter (manufactured by Murakami Color Research Institute, product name: HM-65W model, in accordance with JIS K 7136). D65 light source was used as a light source.

The results are shown in Tables 2 to 4.

TABLE 2

| | Unit, | Com.- | | | Com.- | Com.- |
|---|---|---|---|---|---|---|
| | etc. | Ex. 1 | Ex. 1 | Ex. 2 | Ex.2 | Ex. 3 |
| (a1) | mass % | 70.0 | 70.0 | 70.0 | 70.0 | 80.0 |
| (b1) | mass % | 30.0 | 30.0 | 30.0 | 30.0 | 20.0 |
| (c1) | mass % | 0.00 | 0.20 | 0.50 | 2.00 | 2.00 |
| (d1) | phr | 0.10 | 0.10 | 0.10 | 0.10 | 0.10 |
| Processing | | ∘ | ∘ | ∘ | Δ | x |
| stability | | | | | | |
| Flame | | V-Non- | V-1 | V-1 | V-1 | — |
| retardance | | conforming | | | | |
| Difference | | basis | 0.06 | 0.18 | 0.50 | — |
| in brightness | | | | | | |
| ΔL*(SCI) | | | | | | |

Com.-Ex.: Comparative Example
Ex.: Example

In Comparative Example 3, since processing stability was low, the evaluation sample for measuring flame retardancy and brightness could not be prepared.

TABLE 3

| | Unit, | Com.- | | | | Com.- |
|---|---|---|---|---|---|---|
| | etc. | Ex. 4 | Ex. 3 | Ex. 4 | Ex. 5 | Ex. 5 |
| (a1) | mass % | 70.0 | 70.0 | 70.0 | 70.0 | 70.0 |
| (b1) | mass % | 30.0 | 30.0 | 30.0 | 30.0 | 30.0 |
| (c1) | mass % | 0.00 | 0.20 | 0.50 | 1.00 | 2.00 |
| Flame | | V-Non- | V-1 | V-1 | V-1 | V-1 |
| retardance | | conforming | | | | |
| Haze | % | 3 | 9 | 17 | 31 | 59 |

Com.-Ex.: Comparative Example
Ex.: Example

TABLE 4

| | Unit, | Com.- | | | Com.- | Com.- | Com.- |
|---|---|---|---|---|---|---|---|
| | etc. | Ex. 6 | Ex. 6 | Ex. 7 | Ex. 7 | Ex. 8 | Ex. 9 |
| (a1) | mass % | 75.0 | 75.0 | 75.0 | 77.5 | 77.5 | 77.5 |
| (b1) | mass % | 25.0 | 25.0 | 25.0 | 22.5 | 22.5 | 22.5 |
| (c1) | mass % | 0.00 | 0.20 | 0.50 | 0.00 | 0.20 | 0.50 |
| Flame | | V-Non- | V-1 | V-1 | V-Non- | V-Non- | V-Non- |
| retardance | | conforming | | | conforming | conforming | conforming |
| Haze | % | 3 | 8 | 16 | 3 | 9 | 23 |

Com.-Ex.: Comparative Example
Ex.: Example

While the invention has been described with reference to example embodiments and examples thereof, the invention is not limited to these embodiments and examples. Various changes that can be understood by those of ordinary skill in the art may be made to forms and details of the present invention without departing from the spirit and scope of the present invention.

The whole or part of the example embodiments disclosed above may be described as, but not limited to, the following supplementary notes.

### Supplementary Note 1

A cellulose-based resin composition comprising:
component (A): cellulose acetate,
component (B): one or more phosphoric acid esters selected from the group consisting of triphenyl phosphate, triethyl phosphate, tributyl phosphate and tricresyl phosphate, and
component (C): an anti-dripping agent,
wherein a content of the component (B) is 25% by mass or more and 30% by mass or less based on 100% by mass of a total content of the component (A) and the component (B), and
a content of the component (C) is 0.01% by mass or more, preferably 0.1% by mass or more, and 1% by mass or less based on 100% by mass of a total content of the component (A), the component (B) and the component (C).

### Supplementary Note 2

The cellulose-based resin composition according to Supplementary note 1, wherein the component (B) comprises triphenyl phosphate.

### Supplementary Note 3

The cellulose-based resin composition according to Supplementary note 1 or 2, wherein the component (C) comprises a fluorine-based anti-dripping agent.

### Supplementary Note 4

The cellulose-based resin composition according to any one of Supplementary notes 1 to 3, wherein the component (C) comprises polytetrafluoroethylene.

### Supplementary Note 5

The cellulose-based resin composition according to any one of Supplementary notes 1 to 4, wherein a haze value of a molded body having a thickness of 500 μm formed of the resin composition which does not comprise a colorant is 35% or less.

### Supplementary Note 6

The cellulose-based resin composition according to any one of Supplementary notes 1 to 5, further comprising a colorant.

### Supplementary Note 7

The cellulose-based resin composition according to Supplementary note 6, wherein the colorant is a carbon black.

### Supplementary Note 8

The cellulose-based resin composition according to Supplementary note 7, wherein the carbon black is an acidic carbon black.

### Supplementary Note 9

A molded body formed using the cellulose-based resin composition according to any one of Supplementary notes 1 to 8.

This application is based upon and claims the benefit of priority from Japanese patent application No. 2021-124854, filed on Jul. 29, 2021, the disclosures of which are incorporated herein in their entirety by reference.

While the invention has been described with reference to example embodiments and examples thereof, the invention is not limited to these embodiments and examples. Various changes that can be understood by those of ordinary skill in the art may be made to forms and details of the present invention without departing from the spirit and scope of the present invention.

What is claimed is:

1. A cellulose-based resin composition comprising:
component (A): cellulose acetate,
component (B): one or more phosphoric acid esters selected from the group consisting of triphenyl phosphate, triethyl phosphate, tributyl phosphate and tricresyl phosphate, and
component (C): an anti-dripping agent,
wherein a content of the component (B) is 25% by mass or more and 30% by mass or less based on 100% by mass of a total content of the component (A) and the component (B), and
a content of the component (C) is 0.01% by mass or more and 1% by mass or less based on 100% by mass of a total content of the component (A), the component (B) and the component (C).

2. The cellulose-based resin composition according to claim 1, wherein the component (B) comprises triphenyl phosphate.

3. The cellulose-based resin composition according to claim 1, wherein the component (C) comprises a fluorine-based anti-dripping agent.

4. The cellulose-based resin composition according to claim 1, wherein the component (C) comprises polytetrafluoroethylene.

5. The cellulose-based resin composition according to claim 1, wherein a haze value of a molded body having a thickness of 500 μm formed of the resin composition which does not comprise a colorant is 35% or less.

6. The cellulose-based resin composition according to claim 1, further comprising a colorant.

7. The cellulose-based resin composition according to claim 6, wherein the colorant is a carbon black.

8. The cellulose-based resin composition according to claim 7, wherein the carbon black is an acidic carbon black.

9. A molded body formed using the cellulose-based resin composition according to claim 1.
